(19) United States
(12) Patent Application Publication
(10) Pub. No.: US 2014/0321793 A1
(43) Pub. Date: Oct. 30, 2014

(54) ELECTRO-OPTIC MODULATOR

(71) Applicant: HON HAI PRECISION INDUSTRY CO., LTD., New Taipei (TW)

(72) Inventor: HSIN-SHUN HUANG, New Taipei (TW)

(73) Assignee: HON HAI PRECISION INDUSTRY CO., LTD., New Taipei (TW)

(21) Appl. No.: 13/972,935

(22) Filed: Aug. 22, 2013

(30) Foreign Application Priority Data
Apr. 26, 2013 (TW) 102115122

(51) Int. Cl. G02F 1/225

(52) U.S. Cl. CPC G02F 1/225
USPC 385/3

(57) ABSTRACT

An electro-optic modulator includes a substrate having a polarization inversion region whose polarization is inverted, and a waveguide embedded in the substrate and including a first branch and a second branch. A portion of the first branch is embedded in the polarization inversion region.

### BACKGROUND

1. Technical Field

The present disclosure relates to a Mach Zehnder electro-optic modulator.

2. Description of Related Art

Mach Zehnder modulators for modulating optical signals are known. Typically a two-armed Mach Zehnder modulator will split an incoming signal into two signals. A sinusoidal electric field is applied to one of the signal paths. This produces a phase shift in the optical signal in that path. The phase shifter optical signal is then recombined with the signal in the other arm. The constructive/destructive recombination of the two optical waves provides a modulation in the intensity of the output optical signal as a function of the applied electric field. Although existing Mach Zehnder modulators can satisfy basic requirements, a new type of Mach Zehnder modulator is still needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic top view of an electro-optic modulator according to one embodiment.

FIG. 2 is a schematic cross-sectional view of the electro-optic modulator of FIG. 1, taken along line II-II of FIG. 1.

### DETAILED DESCRIPTION

Embodiments of the present disclosure will be described with reference to the accompanying drawings.

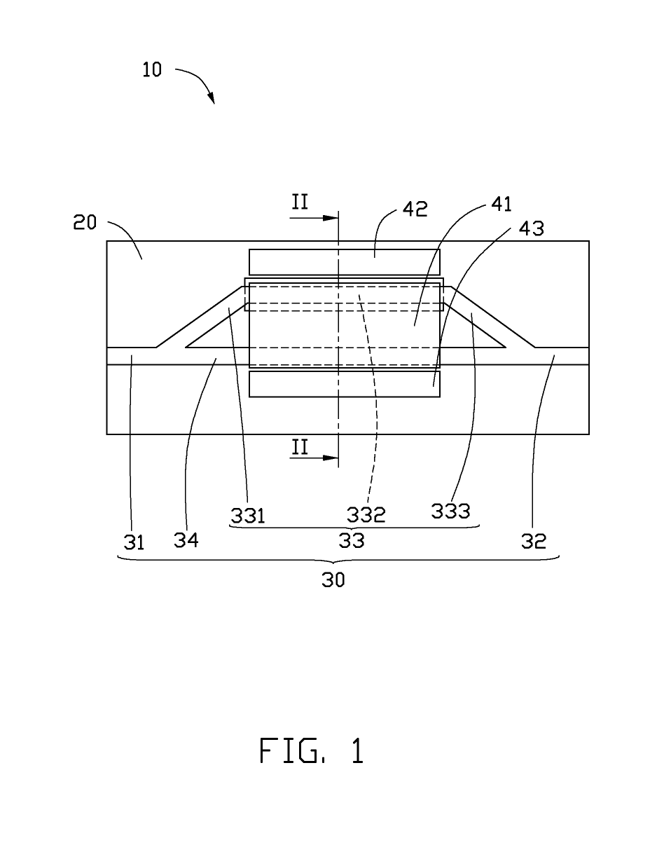

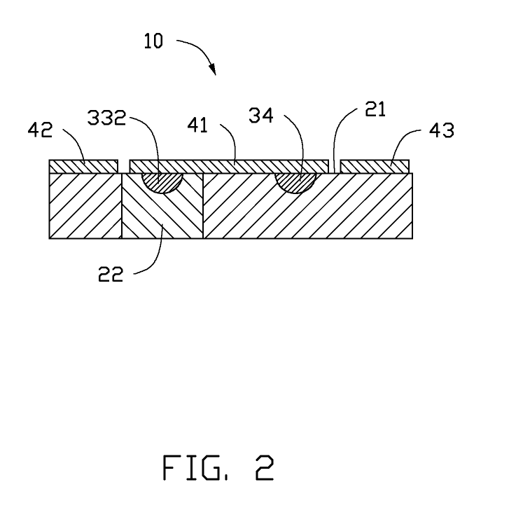

Referring to FIGS. 1 and 2, a Mach Zehnder electro-optic modulator 10 includes a substrate 20 and a wave guide 30 embedded in the top surface 21 of the substrate 20. The wave guide 30 includes an input section 31, an output section 32, a first branch 33, and a second branch 34.

In the embodiment, the substrate 20 is made of lithium niobate (LiNbO3) crystal that can increase a bandwidth of the electro-optic modulator 10 as the LiNbO3 crystal has a high response speed.

In the embodiment, the input section 31 and the output section 32 are formed by diffusing titanium into the substrate 20. The first branch 33 is formed by diffusing titanium into the substrate and then diffusing zinc-nickel alloy into the substrate 20. The second branch 34 is formed by diffusing titanium into the substrate and then further diffusing Gallium into the substrate 20.

In the embodiment, the input section 31, the output section 32, and the second branch 34 extend along the same straight line. The first branch 33 includes two oblique portions 331 that are connected to the second branch 33 at its opposite ends. The first branch 33 further includes a parallel portion 332 that is parallel to the second branch 34, and connected to the oblique portions 331 at their ends.

In the embodiment, the substrate 20 includes a polarization inversion region 22 whose polarization is inverted, and the parallel portion 332 is embedded in the polarization inversion region 22. For forming the polarization inversion region 22, an electric field of at least 21 kV/mm is applied to a desired area of the substrate 20. The polarization of the rest portion of the substrate 20 is not inverted, and the second branch 34 is embedded in the rest portion of the substrate 20.

In the embodiment, the electro-optic modulator 10 further includes a first electrode 41, a second electrode 42, and a third electrode 43 that are arranged on the top surface 21 of the substrate 20. The first electrode 41 is wider than the electrodes 42 and 43, and covers the parallel portion 332 and the second branch 34. The electrodes 42 and 43 are located adjacent to opposite sides of the first electrode 41.

Since the parallel portion 332 of the first branch 33 is implanted in the polarization inversion region 22 and the second branch 34 is implanted in a non-polarization-inverted region, the electromagnetic waves traversing the first branch and the second branch can have a phase difference of 180 degrees when the directions of electric fields applied to the parallel portion 332 and the second branch 34 are the same.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. An electro-optic modulator comprising:
a substrate comprising a polarization inversion region whose polarization is inverted; and
a waveguide embedded in the substrate and comprising a first branch and a second branch, wherein a portion of the first branch is embedded in the polarization inversion region.

2. The electro-optic modulator according to claim 1, wherein the substrate is made of lithium niobate crystal.

3. The electro-optic modulator according to claim 1, wherein the first branch and the second branch are formed by diffusing titanium into the substrate.

4. The electro-optic modulator according to claim 1, wherein the first branch comprises two oblique portions that are obliquely connected to opposite ends of the second branch, and a parallel portion parallel to the second branch.

5. The electro-optic modulator according to claim 4, wherein the parallel portion of the first branch is embedded in the polarization inversion region.

6. The electro-optic modulator according to claim 1, further comprising a first electrode, a second electrode, and a third electrode, wherein the first electrode covers the parallel portion of the first branch and the second branch, and the second electrode and the third electrode are located adjacent to opposite sides of the first electrode.
